(19) United States
(12) Patent Application Publication
(10) Pub. No.: US 2014/0245914 A1
(43) Pub. Date: Sep. 4, 2014

(54) METHOD OF MOUNTING A FLEXOGRAPHIC PRINTING PLATE TO AVOID BANDING

(71) Applicants: Evan M. Goldberg, The Woodlands, TX (US); Christopher Derichs, Buda, TX (US); Kevin J. Derichs, Buda, TX (US); Terry P. Kennair, Houston, TX (US)

(72) Inventors: Evan M. Goldberg, The Woodlands, TX (US); Christopher Derichs, Buda, TX (US); Kevin J. Derichs, Buda, TX (US); Terry P. Kennair, Houston, TX (US)

(73) Assignee: UNI-PIXEL DISPLAYS, INC., The Woodlands, TX (US)

(21) Appl. No.: 14/252,945

(22) Filed: Apr. 15, 2014

Related U.S. Application Data
(63) Continuation-in-part of application No. 13/784,765, filed on Mar. 4, 2013.

(51) Int. Cl. B41M 1/04

(52) U.S. Cl. CPC B41M 1/04
USPC 101/142; 156/185

(57) ABSTRACT

A method of mounting a flexographic printing plate includes disposing a backing tape on a printing plate cylinder forming a taped printing plate cylinder. A transverse center of the flexographic printing plate is attached to the taped printing plate cylinder at a mount line offset relative to a scribe line of the printing plate cylinder. A first portion of the flexographic printing plate is wrapped around a first portion of the taped printing plate cylinder from the mount line outward in a first direction away from the mount line. A second portion of the flexographic printing plate is wrapped around a second portion of the taped printing plate cylinder from the mount line outward in a second direction away from the mount line. The mount line is offset relative to the scribe line at a distance that ensures banding occurs in a non-patterned non-printing area of the flexographic printing plate.

### CROSS-REFRENCE TO RELATED APPLICATIONS

This application is a continuation-in-part of U.S. patent application Ser. No. 13/784,765, filed on Mar. 4, 2013, which is hereby incorporated by reference in its entirety.

### BACKGROUND OF THE INVENTION

A touch screen enabled system allows a user to control various aspects of the system by touch or gestures. For example, a user may interact directly with objects depicted on a display device by touch or gestures that are sensed by a touch sensor. The touch sensor typically includes a pattern of conductive lines disposed on a substrate configured to sense touch.

Touch screens are commonly found in consumer systems, commercial systems, and industrial systems including, but not limited to, smartphones, tablet computers, laptop computers, desktop computers, printers, monitors, televisions, appliances, kiosks, copiers, desktop phones, automotive display systems, portable gaming devices, and gaming consoles.

### BRIEF SUMMARY OF THE INVENTION

According to one aspect of one or more embodiments of the present invention, a method of mounting a flexographic printing plate includes disposing a backing tape on a printing plate cylinder forming a taped printing plate cylinder. A transverse center of the flexographic printing plate is attached to the taped printing plate cylinder at a mount line offset relative to a scribe line of the printing plate cylinder. A first portion of the flexographic printing plate is wrapped around a first portion of the taped printing plate cylinder from the mount line outward in a first direction away from the mount line. A second portion of the flexographic printing plate is wrapped around a second portion of the taped printing plate cylinder from the mount line outward in a second direction away from the mount line. The mount line is offset relative to the scribe line at a distance that ensures banding occurs in a non-patterned non-printing area of the flexographic printing plate.

According to one aspect of one or more embodiments of the present invention, a flexographic printing station includes a printing plate cylinder that includes a scribe line, a backing tape disposed on the printing plate cylinder forming a taped printing plate cylinder, and a flexographic printing plate disposed on the taped printing plate cylinder. The flexographic printing plate is disposed on the taped printing plate cylinder by a process that includes attaching a transverse center of the flexographic printing plate to the taped printing plate cylinder at a mount line offset relative to the scribe line, wrapping a first portion of the flexographic printing plate around a first portion of the taped printing plate cylinder from the mount line outward in a first direction away from the mount line, and wrapping a second portion of the flexographic printing plate around a second portion of the taped printing plate cylinder from the mount line outward in second direction away from the mount line. The mount line is offset relative to the scribe line at a distance that ensures banding occurs in a non-patterned non-printing area of the flexographic printing plate.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled computing system in accordance with one or more embodiments of the present invention.

FIG. 3 shows a conductive pattern disposed on a transparent substrate as part of a touch sensor in accordance with one or more embodiments of the present invention.

FIG. 4 shows a flexographic printing station in accordance with one or more embodiments of the present invention.

FIG. 5 shows a printing plate cylinder with backing tape in accordance with one or more embodiments of the present invention.

FIG. 6 shows a flexographic printing plate with a patterned printing area and a non-patterned non-printing area in accordance with one or more embodiments of the present invention.

FIG. 7 shows a method of mounting a flexographic printing plate to avoid banding in accordance with one or more embodiments of the present invention.

FIG. 8 shows a plurality of mount lines and the corresponding locations of banding in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

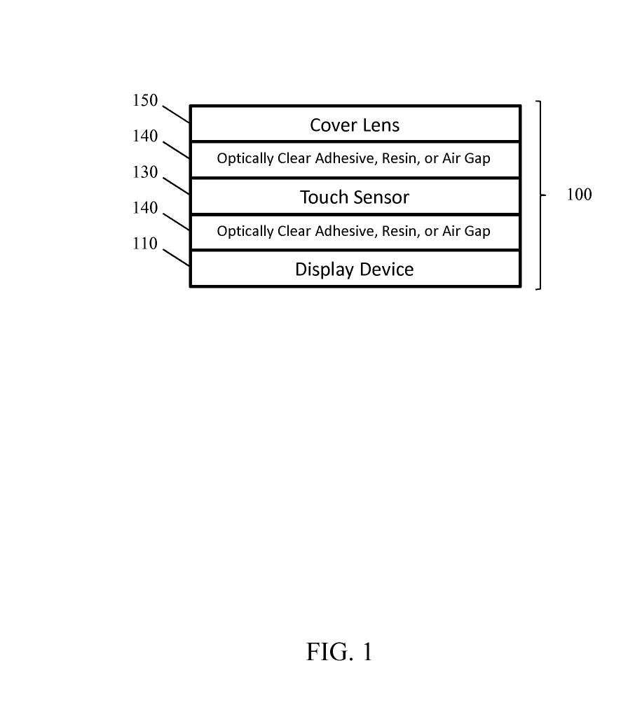

FIG. 1 shows a cross-section of a touch screen 100 in accordance with one or more embodiments of the present invention. Touch screen 100 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, touch screen 100 may include a touch sensor 130 that overlays at least a portion of a viewable area of display device 110. In certain embodiments, an optically clear adhesive or resin 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110. A cover lens 150 may overlay touch sensor 130. Cover lens 150 may be composed of glass, plastic, film, or other material. In certain embodiments, an optically clear adhesive or resin 140 may bond a bottom side of cover lens 150 to a top, or user-facing, side of touch sensor 130. In other embodiments, an isolation layer, or air gap, 140 may separate the bottom side of cover lens 150 and the top, or user-facing, side of touch sensor 130. A top side of cover lens 150 faces the user and protects the underlying components of touch screen 100. In one or more embodiments of the present invention, touch sensor 130, or the function that it implements, may be integrated into a display device 110 (not independently illustrated). One of ordinary skill in the art will recognize that touch sensor 130 may be a capacitive, resistive, optical, acoustic, or any other type of touch sensor technology capable of sensing touch.

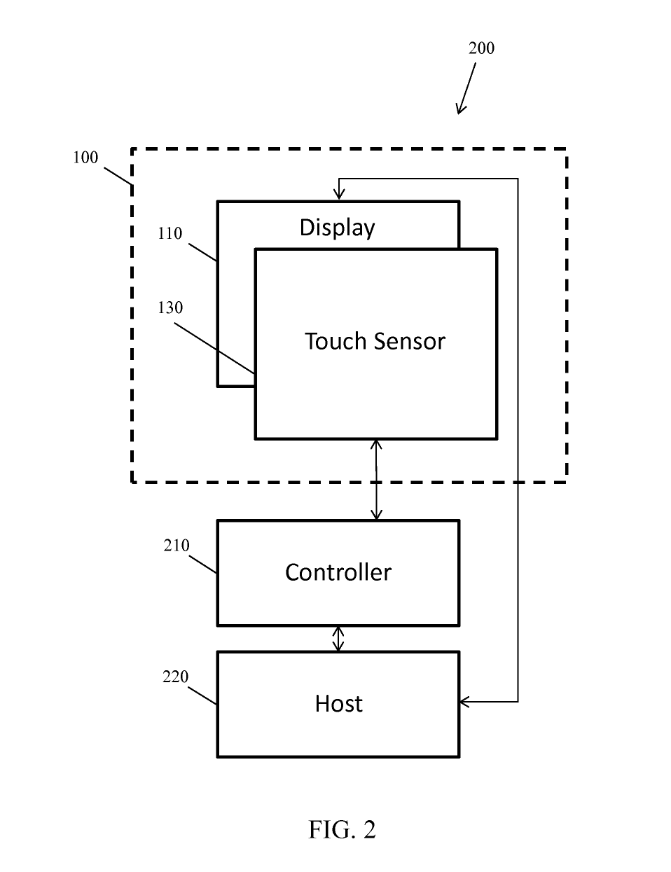

FIG. 2 shows a schematic view of a touch screen enabled computing system 200 in accordance with one or more embodiments of the present invention. Computing system 200 may be a consumer computing system, commercial computing system, or industrial computing system including, but not limited to, smartphones, tablet computers, laptop computers, desktop computers, printers, monitors, televisions, appliances, kiosks, automatic teller machines, copiers, desktop phones, automotive display systems, portable gaming devices, gaming consoles, or other applications or designs suitable for use with touch screen 100. Computing system 200 may include one or more printed or flex circuits (not shown) on which one or more processors (not shown) and system memory (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). Computing system 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including network-attached storage devices and cloud-based storage devices.

In certain embodiments, touch screen 100 may include touch sensor 130 that overlays at least a portion of a viewable area of display device 110. In other embodiments, touch sensor 130, or the function that it implements, may be integrated into display device 110 (not independently illustrated). Controller 210 electrically drives at least a portion of touch sensor 130. Touch sensor 130 senses touch (e.g., capacitance, resistance, optical, or acoustic) and conveys information corresponding to the sensed touch to controller 210. In typical applications, the manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as input and respond in an appropriate manner. In this way, the user may interact with computing system 200 by touch or gestures on touch screen 100. In certain embodiments, host 220 may be the one or more printed or flex circuits (not shown) on which the one or more processors (not shown) are disposed. In other embodiments, host 220 may be a subsystem or any other part of computing system 200 that is configured to interface with display device 110 and controller 210.

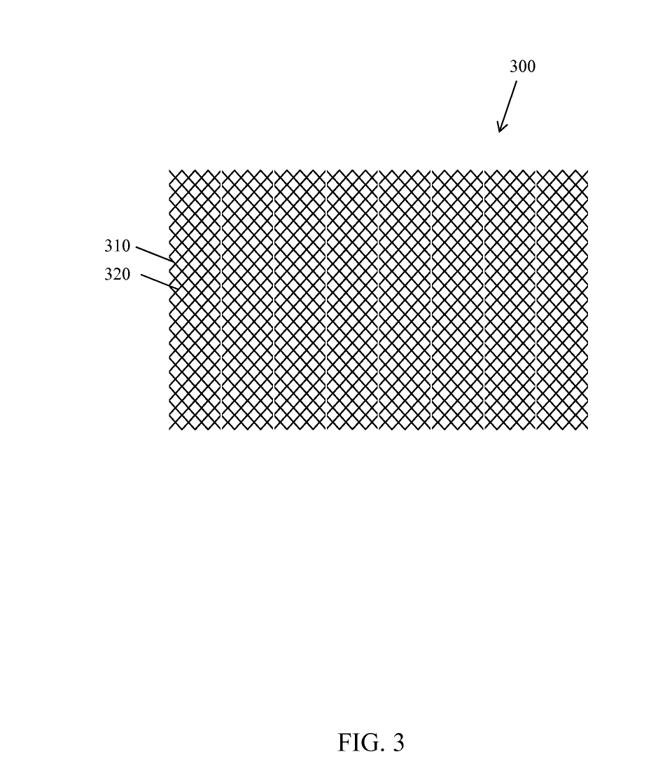

FIG. 3 shows a conductive pattern 300 disposed on a transparent substrate as part of a touch sensor (130 of FIG. 1) in accordance with one or more embodiments of the present invention. In certain embodiments, a conductive pattern 300 may include a mesh formed by a plurality of parallel conductive lines oriented in a first direction 310 and a plurality of parallel conductive lines oriented in a second direction 320 that are disposed on a side of a transparent substrate (not independently illustrated). One of ordinary skill in the art will recognize that the number of parallel conductive lines oriented in the first direction 310 and/or the number of parallel conductive lines oriented in the second direction 320 may vary based on an application or design. One of ordinary skill in the art will also recognize that a size of conductive pattern 300 may vary based on an application or a design. In other embodiments, conductive pattern 300 may include any other shape or pattern formed by one or more conductive lines or features (not independently illustrated). One of ordinary skill in the art will recognize that a conductive pattern is not limited to parallel conductive lines and may be any one or more of predetermined orientations of line segments, random orientations of line segments, curved line segments, conductive particles, polygons, or any other shape(s) or pattern(s) comprised of electrically conductive material (not independently illustrated) in accordance with one or more embodiments of the present invention.

In certain embodiments, one or more of the plurality of parallel conductive lines oriented in the first direction 310 and one or more of the plurality of parallel conductive lines oriented in the second direction 320 may have a line width less than approximately 5 micrometers. In other embodiments, one or more of the plurality of parallel conductive lines oriented in the first direction 310 and one or more of the plurality of parallel conductive lines oriented in the second direction 320 may have a line width in a range between approximately 5 micrometers and approximately 10 micrometers. In still other embodiments, one or more of the plurality of parallel conductive lines oriented in the first direction 310 and one or more of the plurality of parallel conductive lines oriented in the second direction 320 may have a line width in a range between approximately 10 micrometers and approximately 50 micrometers. One of ordinary skill in the art will recognize that the shape and width of one or more of the plurality of parallel conductive lines oriented in the first direction 310 and one or more of the plurality of parallel conductive lines oriented in the second direction 320 may vary based on an application or a design in accordance with one or more embodiments of the present invention.

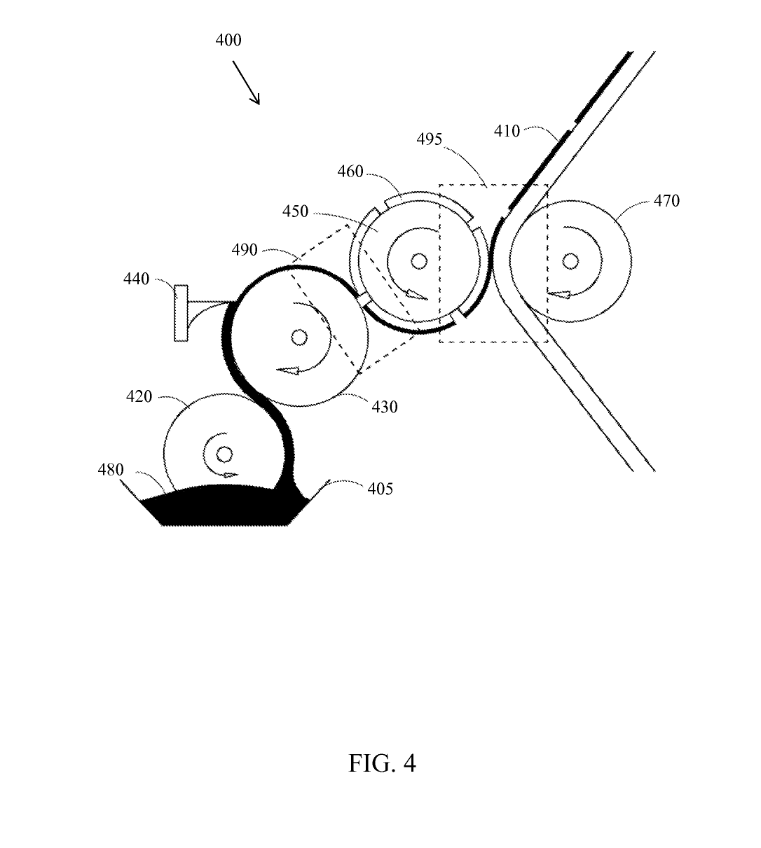

FIG. 4 shows a flexographic printing station 400 in accordance with one or more embodiments of the present invention. Flexographic printing station 400 may include an ink pan 405, an ink roll 420 (also referred to as a fountain roll), an anilox roll 430 (also referred to as a meter roll), a doctor blade 440, a printing plate cylinder 450, a flexographic printing plate 460, and an impression cylinder 470. Flexographic printing plate 460 may include a patterned printing area (not shown) and a non-patterned non-printing area (not shown). The patterned printing area may comprise a pattern to be printed on substrate 410. The non-patterned non-printing area may be the area other than the patterned printing area that is not used to print on substrate 410.

In operation, ink roll 420 transfers ink 480 from ink pan 405 to anilox roll 430. In certain embodiments, ink 480 may be a precursor ink, a catalytic ink, or a catalytic alloy ink that serves as a plating seed suitable for metallization by electroless plating, immersion, and/or other buildup processes. In other embodiments, ink 480 may be any other conductive ink or material. In still other embodiments, ink 480 may be non-conductive ink or material. One of ordinary skill in the art will recognize that the composition of ink 480 may vary based on an application or a design. Anilox roll 430 is typically constructed of a steel or aluminum core that may be coated by an industrial ceramic whose surface contains a plurality of very fine dimples, also referred to as cells (not shown). Doctor blade 440 removes excess ink 480 from anilox roll 430. In transfer area 490, anilox roll 430 meters the amount of ink 480 transferred to flexographic printing plate 460 to a uniform thickness. Printing plate cylinder 450 is typically constructed of a metal such as steel or the like. Flexographic printing plate 460 may be mounted to printing plate cylinder 450 by an adhesive or backing tape (not shown). One or more substrates 410 move between printing plate cylinder 450 and impression cylinder 470. Impression cylinder 470 is typically constructed of metal that is coated with an abrasion resistant coating. Impression cylinder 470 applies pressure to printing plate cylinder 450, transferring an ink 480 image of the patterned printing area (not shown) from flexographic printing plate 460 onto substrate 410 at transfer area 495. The rotational speed of printing plate cylinder 450 is synchronized to match the speed at which substrate 410 moves through flexographic printing station 400. The speed may vary between 20 feet per minute to 750 feet per minute.

In certain touch sensor embodiments, the patterned printing area may comprise at least a portion of an image of a conductive pattern (e.g., conductive pattern 300). One or more flexographic printing stations 400 may be used to dispose a precursor ink, a catalytic ink, or a catalytic alloy ink 480 image (not independently illustrated) of one or more conductive patterns (e.g., conductive pattern 300) on one or more sides of one or more substrates 410. Subsequent to flexographic printing, the precursor ink, the catalytic ink, or the catalytic alloy ink image (not shown) may be metallized by one or more of an electroless plating process, an immersion bathing process, and/or other buildup processes, forming one or more conductive patterns (e.g., conductive pattern 300) on one or more sides of one or more substrates 410. In other embodiments, one or more flexographic printing stations 400 may be used to directly print a conductive pattern (e.g., conductive pattern 300) comprised of conductive ink or material 480 on one or more sides of one or more substrates 410. In one or more embodiments of the present invention, substrate 410 may be transparent. Transparent means capable of transmitting a substantial portion of visible light through the substrate. In certain embodiments, substrate 410 may comprise polyethylene terephthalate (“PET”), polyethylene naphthalate (“PEN”), cellulose acetate (“TAC”), cycloaliphatic hydrocarbons (“COP”), bi-axially-oriented polypropylene (“BOPP”), polyester, polycarbonate, glass, or combinations thereof. In other embodiments, substrate 410 may comprise any other material suitable for use as a touch sensor substrate. One of ordinary skill in the art will recognize that the composition of substrate 410 may vary based on an application or design in accordance with one or more embodiments of the present invention.

In certain non-touch sensor embodiments, the patterned printing area may comprise an image of any other pattern suitable for flexographic printing. One or more flexographic printing stations 400 may be used to print an ink 480 image (not independently illustrated) of one or more patterns (conductive or non-conductive) on one or more sides of one or more substrates 410. In certain embodiments, when the image is printed on substrate 410 as part of a non-touch sensor embodiment, substrate 410 may be transparent or opaque depending on an application or design. One of ordinary skill in the art will recognize that, in addition to the transparent substrates discussed above, any opaque substrate suitable for use in a flexographic printing process may be used in accordance with one or more embodiments of the present invention.

When a flexographic printing station 400 is used to print a patterned printing area (not independently illustrated) on substrate 410, a number of issues may arise that affect the quality of the printed pattern. For example, a backing tape (not independently illustrated) disposed on printing plate cylinder 450 may have a gap or otherwise imperfect seam. The flexographic printing plate 460 attached to the taped printing plate cylinder 450 may have a gap or otherwise imperfect seam. When anilox roll 430 rotates, one or more of these gaps may result in anilox roll 430 bumping flexographic printing plate 460 during flexographic printing operations. When anilox roll 430 bumps flexographic printing plate 460, flexographic printing plate 460 may transfer ink or other material 480 to substrate 410 in a non-uniform manner. A bump may also result in banding during flexographic printing operations. When anilox roll 430 bumps flexographic printing plate 460, flexographic printing plate 460 may transfer unintended ink or other material 480, that are not part of patterned printing area, to substrate 410. When the banding is in the patterned printing area, the unintended ink or other material 480 may degrade the printed pattern on substrate 410. In touch sensor embodiments, banding may cause electrical shorts, electrical opens, and other failure modes. These issues and others are exacerbated when the feature size, such as the width, of lines or features of the patterned printing area are micrometer-fine.

In one or more embodiments of the present invention, a method of mounting a flexographic printing plate prevents banding in a patterned printing area.

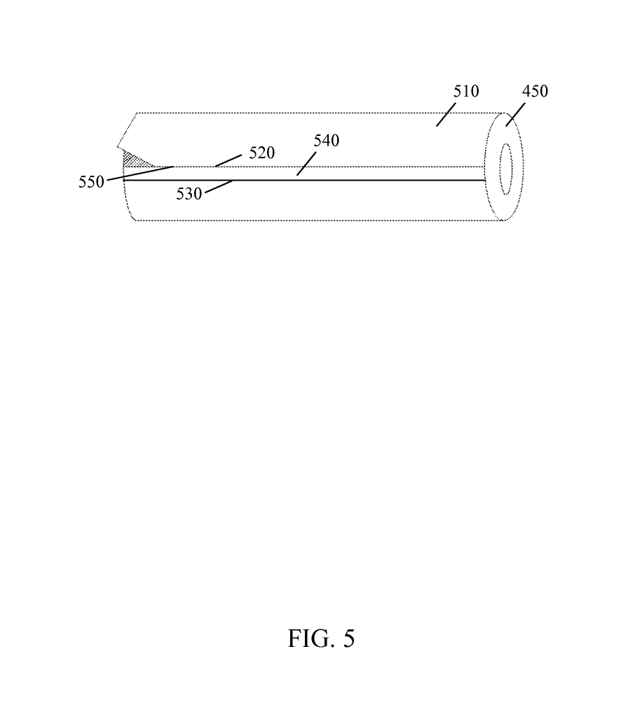

FIG. 5 shows a printing plate cylinder 450 with backing tape 510 in accordance with one or more embodiments of the present invention. In certain embodiments, printing plate cylinder 450 may be an 18⅞-inch circumference, 151-tooth drum-type printing plate cylinder. In other embodiments, printing plate cylinder 450 may be a 24-inch circumference, 192-tooth drum-type printing plate cylinder. In still other embodiments, printing plate cylinder 450 may be a 12-inch circumference, 96-tooth drum-type printing plate cylinder. In still other embodiments, printing plate cylinder 450 may have a size in a range between approximately 12 inches and approximately 24 inches and a tooth count in a range between approximately 96 teeth and approximately 192 teeth. One of ordinary skill in the art will recognize that a circumference and a number of teeth of printing plate cylinder 450 may vary based on an application or design in accordance with one or more embodiments of the present invention. A double-sided backing tape 510 may be disposed on printing plate cylinder 450 forming a taped printing plate cylinder 450. A first side of backing tape 510 may adhere to printing plate cylinder 450 and a flexographic printing plate (460 of FIG. 4) may then adhere to a second side of backing tape 510.

In one or more embodiments of the present invention, backing tape 510 may be disposed on at least a portion of, and in some cases all of, a circumferential surface of printing plate cylinder 450 by attaching a first end 520 of backing tape 510 to printing plate cylinder 450 at a scribe line 550. Scribe line 550 is an indentation along a longitude of printing plate cylinder 450 that may be used to locate a longitudinal center of printing plate cylinder 450 and make a clean cut. Backing tape 510 is then wrapped around at least a portion of, and in some cases all of, a circumferential surface of printing plate cylinder 450. A second end 530 of backing tape 510 may be cut at a cut line (not independently illustrated). In certain embodiments, the cut line may be scribe line 550 such that the second end 530 of backing tape 510 is cut along scribe line 550 forming a seam (not independently illustrated) with the first end 520 of backing tape 510. The seam may be imperfect. In other embodiments, the cut line may be offset from the scribe line 550 such that there is a gap 540 between the first end 520 of backing tape 510 and the second end 530 of backing tape 510. The exposed portion of printing plate cylinder 450 in gap 540 may not be level with backing tape 510.

In one or more embodiments of the present invention, backing tape 510 may be disposed on at least a portion of, and in some cases all of, a circumferential surface of printing plate cylinder 450 by attaching a first end 520 of backing tape 510 to printing plate cylinder 450 at an offset line (not shown) that is offset from the scribe line 550. Backing tape 510 is then wrapped around at least a portion, but sometimes the entire, circumferential surface of printing plate cylinder 450. A second end 530 of backing tape 510 may be cut at a cut line (not independently illustrated). In certain embodiments, the cut line may be the offset line such that the second end 530 of backing tape 510 is cut along the offset line forming a seam (not shown) with the first end 520 of backing tape 510. The seam may be imperfect. In other embodiments, the cut line may be offset from the offset line such that there is a gap (not shown) between the first end 520 of backing tape 510 and the second end 530 of backing tape 510. The exposed portion of printing plate cylinder 450 in gap 540 may not be level with backing tape 510. One of ordinary skill in the art will recognize that other techniques for mounting backing tape 510 to printing plate cylinder 450 may be used in accordance with one or more embodiments of the present invention.

In certain embodiments, backing tape 510 may comprise ChannalBAC™ structured patterned backing tape commercially available from Controlled Displacement™ Technology LLC of Parkland, Fla. ChannalBAC™ differs from cellular foam in that ChannalBAC™ completely separates the air and elastomeric components by forming solid elastomeric channels separated by channels of air within its membrane. As such, ChannalBAC™ cannot be crushed like cellular foam and resists fatigue and deformation in a spring-like manner. Because of the more uniform density and resistance when compared to cellular foam, ChannalBAC™ provides a more uniform and consistent transfer of ink (480 of FIG. 4) from a flexographic printing plate (460 of FIG. 4) to substrate (410 of FIG. 4). In other embodiments, backing tape 510 may comprise a cellular foam backing tape. One of ordinary skill in the art will recognize that a type of backing tape 510 may vary based on an application or design in accordance with one or more embodiments of the present invention.

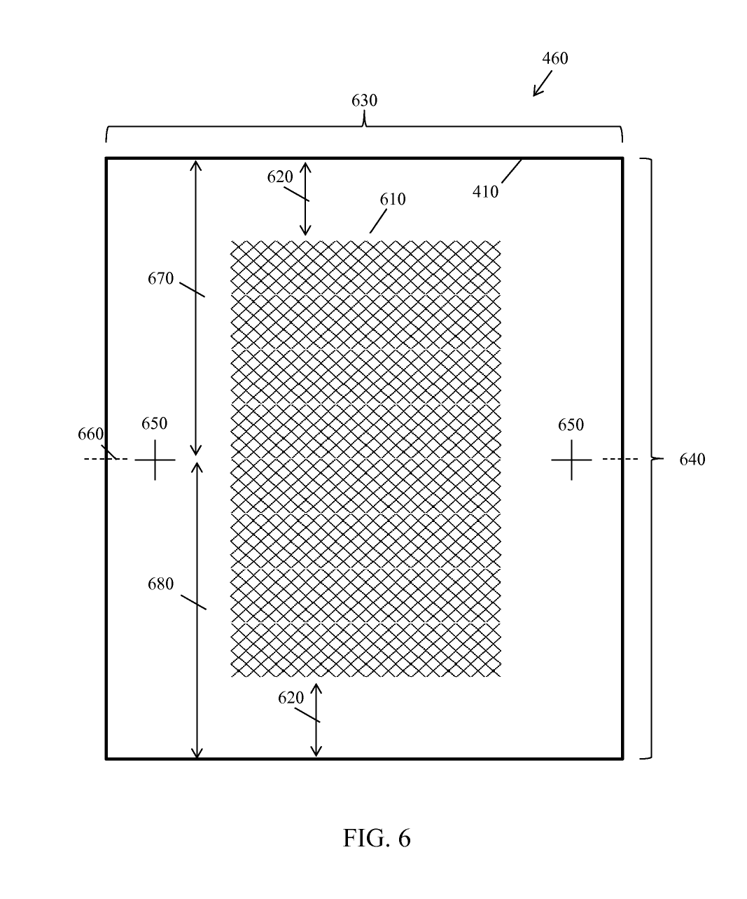

FIG. 6 shows a flexographic printing plate 460 with a patterned printing area 610 and a non-patterned non-printing area 620 in accordance with one or more embodiments of the present invention. In one or more embodiments of the present invention, flexographic printing plate 460 may be comprised of a base layer (not independently illustrated) such as, for example, PET and a photo-sensitive polymer layer (not independently illustrated) disposed on top of the base layer. A plurality of lines or features (not independently illustrated) may be formed in a portion of the photo-sensitive polymer layer forming a patterned printing area 610. A portion of the photo-sensitive polymer layer in the area other than patterned printing area 610, such as non-patterned non-printing area 620, may be removed during fabrication of flexographic printing plate 460. As such, flexographic printing plate 460 includes non-patterned non-printing area 620 and patterned printing area 610 that has distal ends, or contact surfaces (not shown), onto which ink or other material (480 of FIG. 4) may be deposited during flexographic printing operations. In this way, flexographic printing plate 460 may print an ink (480 of FIG. 4) image of patterned printing area 610 on a substrate (410 of FIG. 4) when used with a flexographic printing station (400 of FIG. 4).

Flexographic printing plate 460 may be substantially rectangular having a width 630 and a length 640. In certain embodiments, flexographic printing plate 460 may have a width 630 of approximately 14 inches. In other embodiments, flexographic printing plate 460 may have a width 630 of approximately 17 inches. In still other embodiments, flexographic printing plate 460 may have a width 630 in a range between approximately 3 inches and approximately 90 inches. In certain embodiments, flexographic printing plate 460 may have a length 640 of approximately 18⅞ inches. In other embodiments, flexographic printing plate 460 may have a length 640 of approximately 24 inches. In still other embodiments, flexographic printing plate 450 may have a length 640 of approximately 12 inches. In still other embodiments, flexographic printing plate 460 may have a length 640 in a range between approximately 12 inches and approximately 24 inches. One of ordinary skill in the art will recognize that a size of flexographic printing plate 460 may vary based on an application or design in accordance with one or more embodiments of the present invention.

The patterned printing area 610 may comprise one or more lines, features, shapes, or patterns. The patterned printing area 610 may be disposed anywhere within the boundaries of flexographic printing plate 460. In certain embodiments, patterned printing area 610 may comprise an image of a conductive pattern (e.g., conductive pattern 300). In other embodiments, patterned printing area 610 may comprise an image of a non-conductive pattern. In still other embodiments, patterned printing area 610 may comprise one or more of lines, features, shapes, or patterns. One of ordinary skill in the art will recognize that a pattern or design of patterned printing area 610 may vary based on an application or design in accordance with one or more embodiments of the present invention.

One or more registration marks 650 may be formed in flexographic printing plate 460 along a transverse center 660 line that traverses a width 630 of flexographic printing plate 460. The transverse center 660 line may or may not be formed in flexographic printing plate 460. In one or more embodiments of the present invention, a location of transverse center 660 along a length 640 of flexographic printing plate 460 may vary based on an application or design. The transverse center 660 may be viewed as partitioning flexographic printing plate 460 into a first portion 670 and a second portion 680. In certain embodiments, the first portion 670 and the second portion 680 may be the same size. In other embodiments, the first portion 670 and the second portion 680 may not be the same size. One of ordinary skill in the art will recognize that the relative size of the first portion 670 and the second portion 680 may vary based on an application or design in accordance with one or more embodiments of the present invention. One of ordinary skill in the art will also recognize that the role of the first portion 670 and the second portion 680 may be reversed in certain applications or designs. The one or more registration marks 650 may be a cross hair pattern used to assist in the alignment of flexographic printing plate 460 to taped printing plate cylinder 450. One of ordinary skill in the art will recognize that the number and the location of the one or more registration marks 650 may vary in accordance with one or more embodiments of the present invention.

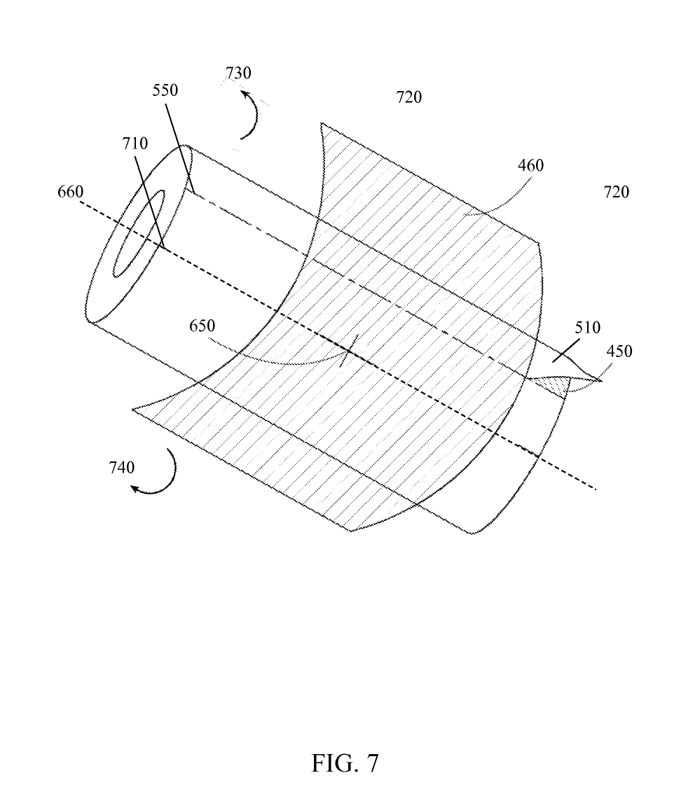

FIG. 7 shows a method of mounting a flexographic printing plate 460 to avoid banding in accordance with one or more embodiments of the present invention. A backing tape 510 may be disposed on printing plate cylinder 450 forming a taped printing plate cylinder 450 as discussed above with reference to FIG. 5. In certain embodiments, a transverse center 660 of flexographic printing plate 460 may be attached to taped printing plate cylinder 450 at a mount line 710 of printing plate cylinder 450 that may be offset relative to a scribe line 550 of printing plate cylinder 450. Because backing tape 510 is tacky, when a portion of flexographic printing plate 460 makes contact with backing tape 510, the portion of flexographic printing plate 460 in contact with backing tape 510 may be secured in place. Mount line 710 is a virtual line that traverses a longitude of printing plate cylinder 450 and is parallel to scribe line 550. Mount line 710 may be used to align flexographic printing plate 460 to printing plate cylinder 450. One or more registration marks 650 may be used to assist in aligning the transverse center 660 of flexographic printing plate cylinder 460 to taped printing plate cylinder 450 along mount line 710. The one or more registration marks 650 may be used with a camera system to ensure alignment of one or more registration marks 650 of flexographic printing plate 460 to mount line 710 of taped printing plate cylinder 450. In other embodiments, a transverse center 660 of flexographic printing plate 460 may be attached to taped printing plate cylinder 450 at a mount line 710 that may be the scribe line 550 of printing plate cylinder 450.

Once the transverse center 660 of flexographic printing plate 460 is attached to taped printing plate cylinder 450 at mount line 710, a first portion (670 of FIG. 6) of flexographic printing plate 460 may be wrapped around a first portion of a circumferential surface of taped printing plate cylinder 450 from mount line 710 outward in a first direction 730 away from mount line 710. A second portion (680 of FIG. 6) of flexographic printing plate 460 may be wrapped around a second portion of the circumferential surface of taped printing plate cylinder 450 from mount line 710 in a second direction 740 away from mount line 710. The first direction 730 and second direction 740 may be perpendicular to mount line 710 about the circumference of taped printing plate cylinder 450. A size of the first portion (670 of FIG. 6) of flexographic printing plate 460 and a size of the second portion (680 of FIG. 6) of flexographic printing plate 460 may vary based on a location of transverse center 660. After mounting flexographic printing plate 460 to taped printing plate cylinder 450, flexographic printing plate 460 may be used in a flexographic printing station (400 of FIG. 4) as part of flexographic printing operations.

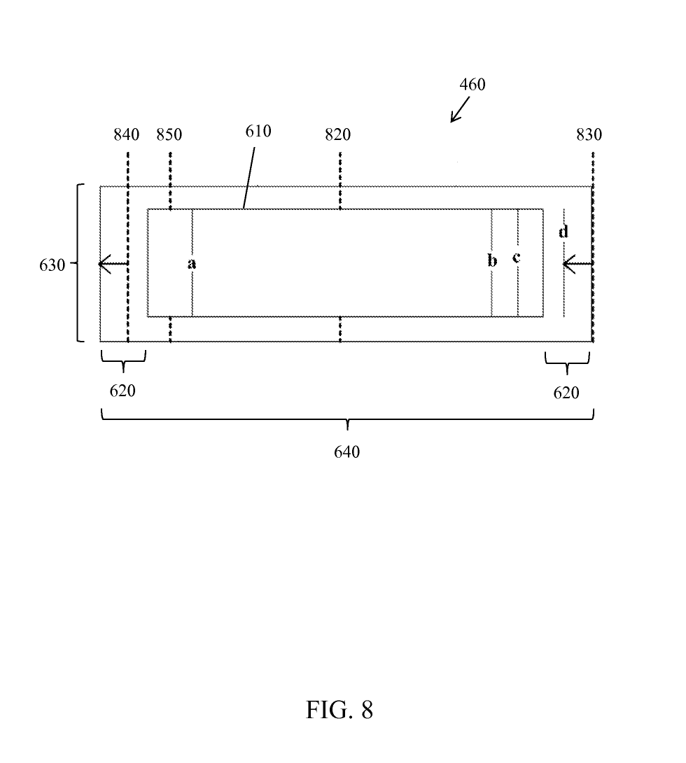

FIG. 8 shows a plurality of mount lines (710 of FIG. 7) and the corresponding locations of banding 810 in accordance with one or more embodiments of the present invention. In certain embodiments, for purposes of illustration, flexographic printing plate 460 may be mounted to an 18⅞-inch, 151-tooth drum-type printing plate cylinder 450 at a mount line (710 of FIG. 7). Flexographic printing plate 460 may have a width 630 of approximately 14 inches and a length 640 of approximately 18⅞ inches suitable for mounting to an 18⅞-inch, 151-tooth drum-type printing plate cylinder 450. One of ordinary skill in the art will recognize that the size and shape of flexographic printing plate 460 and printing plate cylinder 450 may vary based on an application or design. A patterned printing area 610 may be disposed on flexographic printing plate 460. Because patterned printing area 610 may vary in shape and/or size, an offset of a mount line (710 of FIG. 7) may vary to ensure that banding occurs in a non-patterned non-printing area 620 on substrate (410 of FIG. 4). As such, an offset of the mount line (710 of FIG. 7) may vary based on an application or design in accordance with one or more embodiments of the present invention. For purposes of illustration, patterned printing area 610 may be represented by a rectangle within which a pattern is disposed to be printed on substrate (410 of FIG. 4). One of ordinary skill in the art will recognize that the patterned printing area 610 may vary in shape and/or size based on an application or design in accordance with one or more embodiments of the present invention. A non-patterned non-printing area 620 may be the area other than the patterned printing area 610 that is not used to print on substrate (410 of FIG. 4).

When a mount line (710 of FIG. 7) is offset relative to a scribe line (550 of FIG. 5), banding may occur on substrate (410 of FIG. 4) at a location that may be determined by the offset. In one or more embodiments of the present invention, a mount line (710 of FIG. 7) may be offset relative to a scribe line (550 of FIG. 5) at a distance that ensures banding occurs on substrate (410 of FIG. 4) in an area corresponding to the non-patterned non-printing area 620 of flexographic printing plate 460. For example, a mount line (710 of FIG. 7) offset 820 approximately 9 inches from an edge of flexographic printing plate 460 (as measured from left to right) relative to a scribe line (550 of FIG. 5) results in banding on substrate (410 of FIG. 4) in an area corresponding to location a of patterned printing area 610 of flexographic printing plate 460. Banding at location a may comprise a transverse line approximately 4.375 inches from an edge of flexographic printing plate 460 as measured from left to right. As such, during flexographic printing operations, anilox roll (430 of FIG. 4) may bump flexographic printing plate 460 resulting in an unintended band on substrate (410 of FIG. 4) in patterned printing area 610, negatively impacting the ability to print micrometer fine lines or features in patterned printing area 610. For example, the banding may cause shorts, opens, or other failure modes.

Continuing the example, a mount line (710 of FIG. 7) offset 830 approximately 18 inches from an edge of flexographic printing plate 460 (as measured from left to right) relative to a scribe line (550 of FIG. 5) results in banding on substrate (410 of FIG. 4) in an area corresponding to location b of patterned printing area 610 of flexographic printing plate 460. Banding at location b may comprise a transverse line approximately 13.25 inches from an edge of flexographic printing plate 460 as measured from left to right. As such, during flexographic printing operations, anilox roll (430 of FIG. 4) may bump flexographic printing plate 460 resulting in an unintended band on substrate (410 of FIG. 4) in patterned printing area 610, negatively impacting the ability to print micrometer fine lines or features in patterned printing area 610. For example, the banding may cause shorts, opens, or other failure modes.

Continuing the example, a mount line (710 of FIG. 7) offset 840 approximately 1 inch from an edge of flexographic printing plate 460 (as measured from left to right) relative to a scribe line (550 of FIG. 5) results in banding on substrate (410 of FIG. 4) in an area corresponding to location c of patterned printing area 610 of flexographic printing plate 460. Banding at location c may comprise a transverse line approximately 14.25 inches from an edge of flexographic printing plate 460 as measured from left to right. As such, during flexographic printing operations, anilox roll (430 of FIG. 4) may bump flexographic printing plate 460 resulting in an unintended band on substrate (410 of FIG. 4) in patterned printing area 610, negatively impacting the ability to print micrometer fine lines or features in patterned printing area 610. For example, the banding may cause shorts, opens, or other failure modes.

However, a mount line (710 of FIG. 7) offset 850 approximately 4 inches from an edge of flexographic printing plate 460 (as measured from left to right) relative to a scribe line (550 of FIG. 5) results in banding on substrate (410 of FIG. 4) in an area corresponding to location d of non-patterned non-printing area 620 of flexographic printing plate cylinder 460. Because banding occurs in the non-patterned non-printing area 620, the banding does not negatively impact the patterned printing area 610 or the corresponding image of the patterned printing area 610 printed on substrate (410 of FIG. 4). In embodiments using an 18⅞-inch, 151-tooth drum-type printing plate cylinder 450, banding may lead a scribe line (550 of FIG. 5) by approximately 4.7 inches. As such, in certain embodiments, a mount line 710 may be offset relative to a scribe line (550 of FIG. 5) at a distance of approximately 4.7 inches to ensure banding occurs in non-patterned non-printing area 620. In other embodiments, mount line 710 may be offset relative to scribe line (550 of FIG. 5) at a distance that ensures banding occurs in non-patterned non-printing area 620.

While the above noted examples are based on an example of a patterned printing area 610, one of ordinary skill in the art will recognize that patterned printing area 610 may vary in shape and/or size. In addition, one of ordinary skill in the art will recognize that an offset of mount line (710 of FIG. 7) may vary based on the shape and/or the size of the patterned printing area 610. For example, a small patterned printing area 610 may have a larger non-patterned non-printing area 620 and an offset of mount line (710 of FIG. 7) may vary as a result. Advantageously, in one or more embodiments of the present invention, a mount line (710 of FIG. 7) may be offset relative to a scribe line (550 of FIG. 5) at a distance that ensures banding occurs in a non-patterned non-printing area of a flexographic printing plate 460.

Advantages of one or more embodiments of the present invention may include one or more of the following:

In one or more embodiments of the present invention, a method of mounting a flexographic printing plate to avoid banding improves mounting precision.

In one or more embodiments of the present invention, a method of mounting a flexographic printing plate to avoid banding ensures banding occurs in a non-patterned non-printing area of a flexographic printing plate. In this way, the banding may be hidden in the non-functional or otherwise unimportant area of the substrate.

In one or more embodiments of the present invention, a method of mounting a flexographic printing plate to avoid banding allows for the flexographic printing of micrometer-fine lines or features on a substrate.

In one or more embodiments of the present invention, a method of mounting a flexographic printing plate to avoid banding allows for more uniform ink transfer when printing micrometer-fine lines or features on a substrate.

In one or more embodiments of the present invention, a method of mounting a flexographic printing plate to avoid banding improves yield when printing fine lines or features on substrate.

In one or more embodiments of the present invention, a method of mounting a flexographic printing plate to avoid banding reduces wear and tear on flexographic printing station components.

In one or more embodiments of the present invention, a method of mounting a flexographic printing plate to avoid banding reduces manufacturing expense, manufacturing time, and manufacturing complexity.

In one or more embodiments of the present invention, a method of mounting a flexographic printing plate to avoid banding is compatible with existing flexographic printing processes.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of mounting a flexographic printing plate comprising:
disposing a backing tape on a printing plate cylinder forming a taped printing plate cylinder;
attaching a transverse center of the flexographic printing plate to the taped printing plate cylinder at a mount line offset relative to a scribe line of the printing plate cylinder;
wrapping a first portion of the flexographic printing plate around a first portion of the taped printing plate cylinder from the mount line outward in a first direction away from the mount line; and
wrapping a second portion of the flexographic printing plate around a second portion of the taped printing plate cylinder from the mount line outward in a second direction away from the mount line,
wherein the mount line is offset relative to the scribe line at a distance that ensures banding occurs in a non-patterned non-printing area of the flexographic printing plate.

2. The method of claim 1, wherein the patterned printing area comprises a plurality of micrometer-fine lines.

3. The method of claim 1, wherein the patterned printing area comprises a mesh formed by a plurality of parallel lines oriented in a first direction and a plurality of parallel conductive lines oriented in a second direction.

4. The method of claim 1, wherein the offset is approximately 4.7 inches.

5. The method of claim 1, wherein disposing the backing tape on the printing plate cylinder comprises:
attaching a first end of the backing tape to the printing plate cylinder at the scribe line;
wrapping the backing tape around the printing plate cylinder; and
cutting a second end of the backing tape at a cut line.

6. The method of claim 5, wherein the cut line is the scribe line.

7. The method of claim 5, wherein the cut line is offset from the scribe line forming a gap between the first end of the backing tape and the second end of the backing tape.

8. The method of claim 1, wherein the backing tape comprises a structured patterned backing tape.

9. The method of claim 8, wherein the structured patterned backing tape comprises ChannalBAC™.

10. The method of claim 1, wherein attaching the transverse center of the flexographic printing plate to the taped printing plate cylinder comprises:
aligning the transverse center of the flexographic printing plate to the mount line; and
disposing the transverse center of the flexographic printing plate on the backing tape.

11. A flexographic printing station comprising:
a printing plate cylinder comprising a scribe line;
a backing tape disposed on the printing plate cylinder forming a taped printing plate cylinder; and
a flexographic printing plate disposed on the taped printing plate cylinder,
wherein the flexographic printing plate is disposed on the taped printing plate cylinder by a process comprising:
attaching a transverse center of the flexographic printing plate to the taped printing plate cylinder at a mount line offset relative to the scribe line,
wrapping a first portion of the flexographic printing plate around a first portion of the taped printing plate cylinder from the mount line outward in a first direction away from the mount line, and
wrapping a second portion of the flexographic printing plate around a second portion of the taped printing plate cylinder from the mount line outward in second direction away from the mount line,
wherein the mount line is offset relative to the scribe line at a distance that ensures banding occurs in a non-patterned non-printing area of the flexographic printing plate.

12. The flexographic printing station of claim 11, wherein the patterned printing area comprises a plurality of micrometer-fine lines.

13. The flexographic printing station of claim 11, wherein the patterned printing area comprises a mesh formed by a plurality of parallel lines oriented in a first direction and a plurality of parallel conductive lines oriented in a second direction.

14. The flexographic printing station of claim 11, wherein the offset is approximately 4.7 inches.

15. The flexographic printing station of claim 11, wherein the backing tape is disposed on the printing plate cylinder by a process comprising:
attaching a first end of the backing tape to the printing plate cylinder at the scribe line;
wrapping the backing tape around the printing plate cylinder; and
cutting a second end of the backing tape at a cut line.

16. The flexographic printing station of claim 15, wherein the cut line is the scribe line.

17. The flexographic printing station of claim 15, wherein the cut line is offset from the scribe line forming a gap between the first end of the backing tape and the second end of the backing tape.

18. The flexographic printing station of claim 11, wherein the backing tape comprises a structured patterned backing tape.

19. The flexographic printing station of claim 18, wherein the structured patterned backing tape comprises ChannalBAC™.

20. The flexographic printing station of claim 11, wherein attaching the transverse center of the flexographic printing plate to the taped printing plate cylinder comprises:
aligning the transverse of the flexographic printing plate to the mount line; and
disposing the transverse center of the flexographic printing plate on the backing tape.
